(19) United States
(12) Patent Application Publication
(10) Pub. No.: US 2019/0331934 A1
(43) Pub. Date: Oct. 31, 2019

(54) EYEWEAR HAVING A SINGLE RELEASE POINT FOR ARM AND LENS INTERCHANGE

(71) Applicant: Steven Larsen Rinehart, Fruit Heights, UT (US)

(72) Inventor: Steven Larsen Rinehart, Fruit Heights, UT (US)

(21) Appl. No.: 15/965,674

(22) Filed: Apr. 27, 2018

(51) Int. Cl. G02C 1/08; G02C 5/14; G02C 5/00

(52) U.S. Cl. CPC G02C 1/08; G02C 2200/06; G02C 5/008; G02C 5/146

(57) ABSTRACT

Eyewear retaining a pair of lenses having one or more eyewires in which each eyewire is adapted to release a detachable lens and detachable hingedly connected arm at a single release point in the eyewire. In some embodiments, the eyewire bifurcates forming a recess to enable lens and/or arm interchange. The recess may absorb pressure applied by the arm hinge mechanism to the eyewires.

### BACKGROUND

### Field of the Invention

This invention relates to eyewear, and more particularly relates to eyewear adapted to have a single release point for the arm(s) and lens(es).

### Description of the Related Art

Traditional eyewear, including glasses, safety goggles and sunglasses, comprise frames and eyewires which securely retain the lenses in front of the eyes. In the case of cast metal eyewires, which have been rare in the art, the lenses have traditionally been released from the eyewires using a different release mechanism that the mechanism securing the arms to the eyewires, unnecessarily weighing down the frames and subverting design freedom.

Glass and sunglass lenses are usually used for vision correction and/or for reducing glare, transmission of sunlight, or brightness to a wearer, and are commonly broken, scratched or rendered inutile. Because sunglasses are ornamental to some extent, or decorative in appearance, and because users often choose sunglass lens colors appealing to their personal tastes without regard for utility, lenses are often interchanged for purely aesthetic reasons. In other instances, lenses are interchanged for medical reasons.

Although nearly all commercially-produced sunglasses are formed from polymeric materials, usually through injection molding to save production costs, there remains a market for sunglasses made from durable aluminum, titanium, or metal allow frames, including sunglasses made from molded rather than stamped metal components. These species of sunglasses were commercially successful in some embodiments, but suffered from a variety of design flaws limiting commercial viability, including limited ability to flex to fit user's with differing head sizes (especially women), weak and flexible nose bridges which distorted while bearing worn, reduced strength frames resulting from attempts to preserve metal in production and reduce weight, and multiple release points in the eyewires for the lenses and arms.

As sunglasses are being worn by ever increasing numbers of people, a market is reemerging for durable metal allow eyewear who believe polymeric sunglasses in any embodiment are cheap. The increasing demand for sunglasses specifically and eyewear generally has resulted in a proliferation of designs for sunglasses. Thus some sunglasses are designed primarily to meet functional objectives, while others are more stylish.

In order the meet the needs unmet by the prior art, the present disclosure is made with an object of the present invention to improve and cure deficiencies in the art. There exists a need in the art for eyewear with a single release point for the arms and lenses, which is inexpensive to manufacture, and adapted to facilitate quick interchanging of lenses.

### SUMMARY

From the foregoing discussion, it should be apparent that a need exists for eyewear with a single release point for the arms and lenses.

The present invention has been developed in response to the present state of the art, and in particular, in response to the problems and needs in the art that have not yet been fully solved by currently available glasses. Accordingly, the present invention has been developed to provide eyewear comprising: two eyewires adapted to circumscribe one or more lenses, each eyewire forming a circuitous rim adapted to receive and secure a lens, wherein circuitous continuity an outside edge of each eyewire is interrupted at only a single interruption point such that the eyewire forms a recess at the single interruption point; wherein each eyewire is adapted to flex open when opposing tensile forces are applied by hand such that the lens can be inserted or extracted under tensile force; two detachable arms, each detachable arm hingedly connected at a proximal end to an eyewire, the proximal end of each arm inserted into the recess of said eyewire, wherein each arm is adapted to rotate axially relative to the eyewire on a longitudinal plane within said recess.

Each eyewire may be substantially annular. Each eyewire may be formed from one of Titanium, a Titanium alloy, aluminum and an aluminum alloy.

In various embodiments, the outside edge is a lateral edge. The outside edge of each eyewire may be a top lateral edge.

Each eyewire may comprise an upper prong cantilevering from the circuitous rim above the recess. Each eyewire may comprise a lower prong cantilevering from the circuitous rim above the recess.

The upper prong and lower prong may be tapped such that they can be screwed toward one another with a single screw.

Both eyewires may be affixed to a nose bridge.

In some embodiments, a surface of the eyewire disposed forward of the upper and lower prongs is concave and adapted to abut a cantilever of a detachable arm.

A screw may join the upper prong, the lower prong and the arm.

Eyewear is provided comprising: two eyewires adapted to circumscribe one or more lenses, each eyewire forming a circuitous rim adapted to receive and secure a lens, wherein circuitous continuity an outside edge of each eyewire is interrupted at only a single interruption point on an outside lateral edge of the rim such that the eyewire forms a recess at the single interruption point; wherein each eyewire is adapted to flex open when opposing tensile forces are applied by hand such that the lens can be inserted or extracted under tensile force; wherein each eyewire comprises an upper prong cantilevering from the circuitous rim above the recess and a lower prong cantilevering from the circuitous rim below the recess; two detachable arms, each detachable arm hingedly connected at a proximal end to an eyewire, the proximal end of each arm inserted into the recess of an eyewire, wherein each arm is adapted to rotate axially relative to the eyewire on a longitudinal plane within said recess; wherein the upper prong and lower prong are tapped such that they can be screwed toward one another with a single screw; a screw joining the upper prong, the lower prong and the arm and wherein the arm; a nose bridge affixed to the eyewires.

Each eyewire may be substantially annular.

Eyewear is also provided comprising: an eyewire adapted to circumscribe one or more lenses and straddle a nose, the eyewire forming one or more circuitous rims, each circuitous rim adapted to receive and secure a lens, wherein circuitous continuity an outside edge of the eyewire is interrupted at a single interruption point on an outside lateral edge of the rim such that the eyewire forms a recess at the single interruption point; wherein the eyewire is adapted to flex open when opposing tensile forces are applied by hand such that the lens can be inserted or extracted under tensile force; wherein the eyewire comprises an upper prong cantilevering from the circuitous rim above the recess and a lower prong cantilevering from the circuitous rim below the recess; two detachable arms, each detachable arm hingedly connected at a proximal end to the eyewire, the proximal end of each arm inserted into a recess of the eyewire, wherein each arm is adapted to rotate axially relative to the eyewire on a longitudinal plane within said recess.

The eyewire may be formed from one of polymeric and organic materials.

The upper and lower prongs may be tapped.

The eyewire may form a recessed groove for receiving the lens. A surface of the eyewire may be disposed forward of the upper and lower prongs is concave and adapted to abut a cantilever of a detachable arm.

The eyewire may further comprise a screw adapted to join the upper prong and the lower prong and the arm such that the arm pivots about a plane orthogonal to a longitudinal axis of the screw.

A rearward surface of the eyewire may be disposed forward of the upper and lower prongs is concave and adapted to receive a squish pad in various embodiments.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a front perspective view of multipurpose eyewear having a single release point in accordance with the present invention;

FIG. 2 is a side perspective view of multipurpose eyewear having a single release point in accordance with the present invention;

FIG. 3 is a front-side perspective view of multipurpose eyewear having a single release point in accordance with the present invention;

FIG. 4A is a front-side perspective view of multipurpose eyewear having a single release point in accordance with the present invention;

FIG. 4B is a rearward perspective view of multipurpose eyewear having a single release point in accordance with the present invention; and

FIG. 5 is a rearward perspective view of squish pad of multipurpose eyewear having a single release point in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

One object of the present invention is to provide eyewear with eyewires adapted to have only a single release point for an arms and lens.

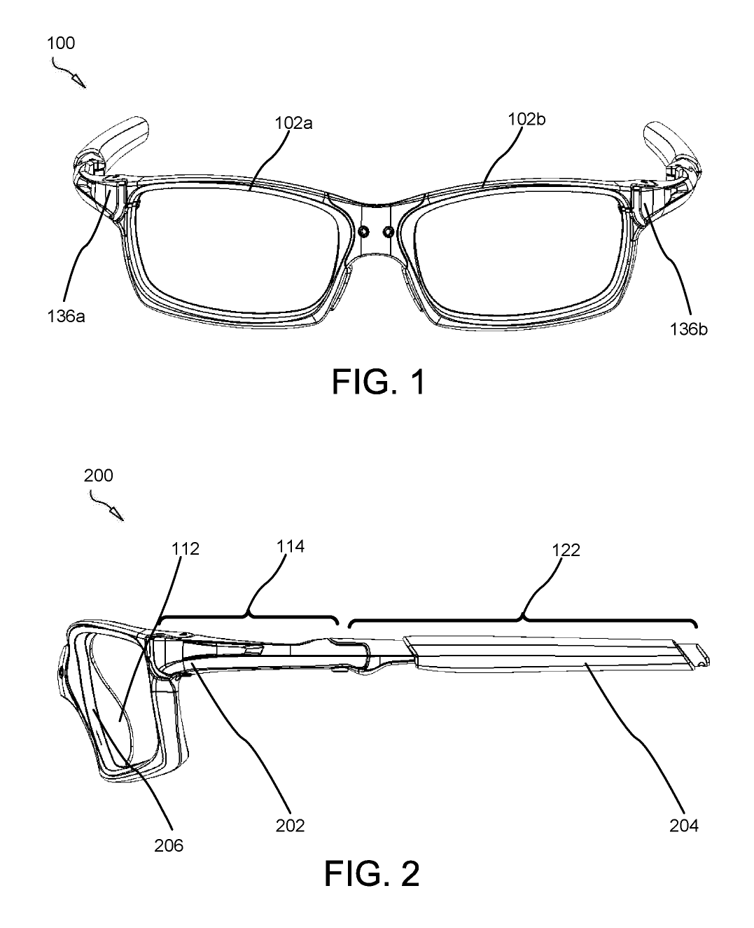

FIG. 1 is a front perspective view of multipurpose eyewear having a single release point 100 in accordance with the present invention. FIGS. 1-2 depicts multipurpose eyewear comprising a pair of forward arms 114 and a pair of rearward arms 122 that pivot laterally, in an inner and outer direction, to increase the width of the glasses 100. The glasses 100 provide multiple components that enhance functionality, comfort, tethering capacity, and aesthetics. The glasses 100 may comprise of a frame 102, a pair of lenses 110a-b, a pair of forward arms 114a-b, and a pair of rearward arms 122a-b. The frame 102 may comprise or consist of an eyewire 102 circumscribing a lens. These components join together to form a dynamic pair of glasses 100 that integrates various components and configurations to provide advantages over the prior art.

As shown in FIG. 1, the frame/eyewire 102 is configured to rest on the nose for supporting the glasses 100. The frame 102 detachably retains a pair of lenses 110a-b. The eyewire 102 is for releasing the lenses. The eyewire 102 can also tighten around the lenses 110a-b using means known to those of skill in the art, including threaded screws. This enables the lenses to be interchanged and securely retained with minimal stress within an eyewire 102.

In various embodiments, two eyewires 102 are permanently or detachably affixed to a nose bridge (indicated at 302 below). In other embodiments, the eyewires 102 are affixed together or formed as a single integrated piece. In these embodiments, a single eyewire 102 envelopes or circumscribes two lenses and is adapted to straddle a wearer's nose.

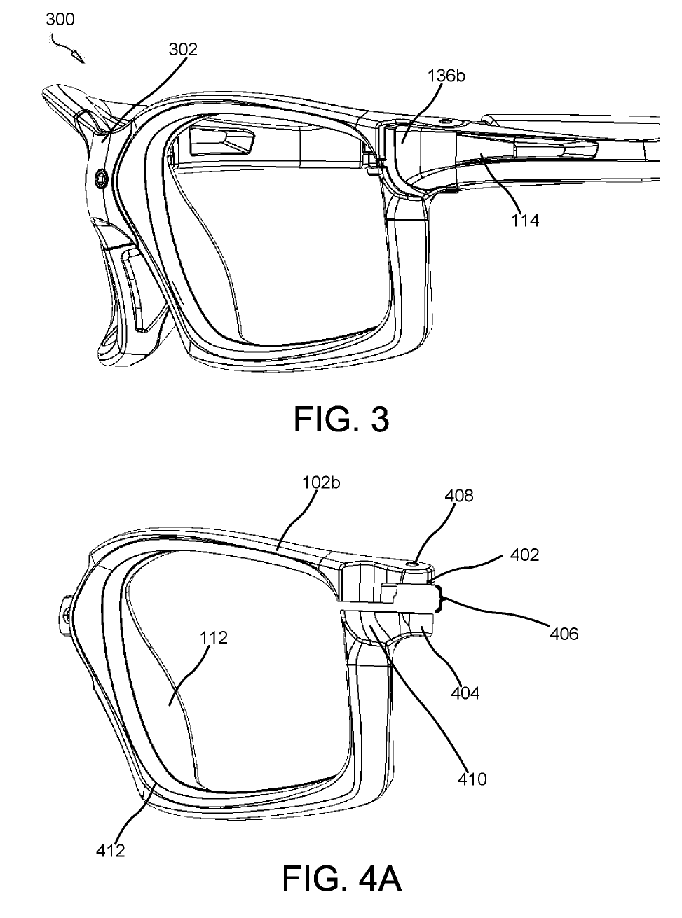

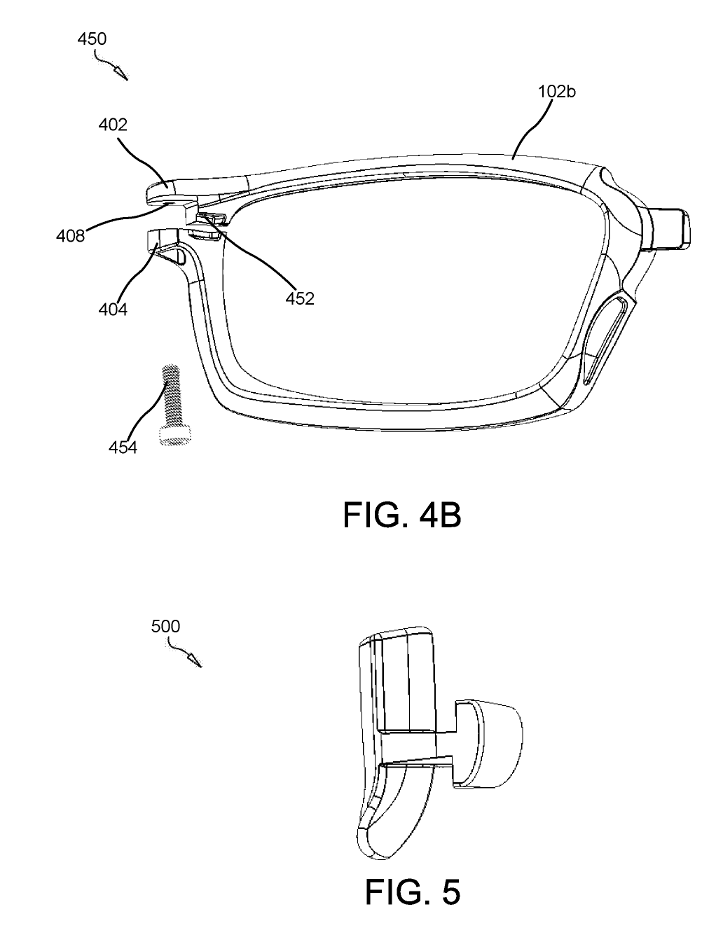

The eyewire 102 in the shown embodiment is interrupted at the point where the arm 114 engages the eyewire 102. The eyewire 102 does not form a single, uninterrupted ovoid circumscribing the entire lens. Rather a break is formed in the outer lateral edge as further described below in relation to FIGS. 3-4B. A pair of forward arms 114 hingedly join the eyewire 102 and insert into the formed recess.

The eyewire 102 may be fabricated from titanium, aluminum, steel, brass, gold, gold plating, carbon fiber, metal alloys, nylon, elastomeric or polymeric materials, or organic materials such as wood, or other materials known to those of skill in the art, using means known to those of skill in the art, including mold injection, 3D printing, or digital metal laser sintering (DMLS).

The proximal end of the arm 114 is indicated at 202 while the distal end is indicated at 204. Each eyewire 102 comprises a circuitous rim 206 adapted to receive and secure an inserted and detachable lens. In some variations, the rim 206 defines a track, groove 412, recess, or slot for receiving the lens.

FIG. 3 is a front-side perspective view of multipurpose eyewear having a single release point 300 in accordance with the present invention. FIG. 3 as shown.

FIG. 4A is a front-side perspective view of multipurpose eyewear having a single release point 400 in accordance with the present invention.

The eyewires 102 affix to a nose bridge 302.

Two prongs 404, 402 form above and below the recess 406 which interrupts the circumscribion of the eyewire 102b. Both the upper prong 402 and the lower prong 404 jut away (in the shown embodiment laterally) from the eyewire 102 for hingedly affixing to an arm 114 or any arm known to those of skill in the art. The upper prong 402 and lower prong 404 cantilever from the main portion of the eyewire 102.

An aperture 408 forms in both the upper prong 408 and the lower prong 404 for receiving a screw, bolt, nut, shaft, rod or other joining member. The aperture 408 may be tapped as known to those of skill in the art. In various embodiments, the arm 114 snaps into recesses in the upper prong 402 and/or the lower prong 404.

When the screw inserting, traversing or positioning within the upper prong 402 and the lower prong 404 is removed, the eyewire 102 flexes with applied tensile for the prongs 402, 404 and/or the top and bottom of the eyewire 102, releasing an enclosed lens. This screw may also be detached to remove, interchange or replace the arm 114.

The pair of glasses 100 may include, without limitation, sunglasses, prescription glasses, wraparound sunglasses, safety glasses, bifocals, welding glasses, goggles, and visors. Suitable materials for the glasses 100 and lenses may include, without limitation, titanium, metal alloy, aluminum, polymeric materials, cellulose acetate, organic materials like wood and ivory, and any combination of materials. The lenses 110a-b may be glass or plastic.

The eyewire 102 forms a generally annular shape that is configured to receive similarly shaped and dimensioned lenses which contour an inner surface of the eyewire 102. Though, in other embodiments, other shapes are possible or preferred. The entire eyewire 102 piece (not just the rim or adjoining section) divides or bifurcates for form the recess 406.

The recess 406 facilitates interchangeability of the lenses and arms. The recess 406 is also adapted to reduce stress that is generated by the pressure and strain applied by the arms to the eyewire 102. The recess 406 also absorbs stress, strains, and pressure that arise from manipulation and donning of the glasses. The recess 406 is defined and disposed at a corner junction of the eyewire 102.

As shown, the arms on the sunglasses 100-400, or in various other embodiments, may comprise a plurality of arm segments, wherein each arm segment comprises a separate component of the arm hingedly connected to either a preceding arm segment or the eyewire 102.

The outer surface of the eyewire 102 disposed in front of the recess 406 may be indented, recessed, or concave such that the surface forms a concave recess 410 for abutting a cantilever 136 on the arm 114 and stopping axial rotation of the arm 114 relative to the eyewire 102 on a lateral or longitudinal plane.

FIG. 4B is a rearward perspective view of multipurpose eyewear having a single release point 450 in accordance with the present invention.

The rearward surface of the eyewire 102 defines a concave recess 452 for receiving a squish pad (indicated generally at 500 in FIG. 5), or polymeric or organic pad held within the recess 406. In some embodiments, this squish pad 500 protrudes outwardly on convex manner to absorb compressive forces applied by the cantilever 136. In this manner, the squish pad 500 allows the arms 114, 122 to flex to accommodate various size heads. The squish pad 500 also serves aesthetic purposes as well as helps absorb impact from the arms 114 when opened and forced against the eyewire 102.

A single screw 454 is used to affix the arm 114 to the eyewire 102 and to close the eyewire 102 at the upper prong 402 and lower prong 404. The arm 144 pivots about the screw 454, which screw is oriented in some embodiments such that its long axis (or longitudinal axis) is orthogonal to the plane of motion of the arm 114.

FIG. 5 is a rearward perspective view of squish pad 500 of multipurpose eyewear having a single release point in accordance with the present invention.

FIG. 5 as shown.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. Eyewear comprising:
two eyewires adapted to circumscribe one or more lenses, each eyewire forming a circuitous rim adapted to receive and secure a lens, wherein circuitous continuity an outside edge of each eyewire is interrupted at only a single interruption point such that the eyewire forms a recess at the single interruption point;
wherein each eyewire is adapted to flex open when opposing tensile forces are applied by hand such that the lens can be inserted or extracted under tensile force;
two detachable arms, each detachable arm hingedly connected at a proximal end to an eyewire, the proximal end of each arm inserted into the recess of said eyewire, wherein each arm is adapted to rotate axially relative to the eyewire on a longitudinal plane within said recess.

2. The eyewear of claim 1, wherein each eyewire is substantially annular.

3. The eyewear of claim 1, wherein each eyewire is formed from one of Titanium, a Titanium alloy, aluminum and an aluminum alloy.

4. The eyewear of claim 1, wherein the outside edge is a lateral edge.

5. The eyewear of claim 1, wherein the outside edge of each eyewire is a top lateral edge.

6. The eyewear of claim 1, wherein each eyewire comprises an upper prong cantilevering from the circuitous rim above the recess.

7. The eyewear of claim 6, wherein each eyewire comprises a lower prong cantilevering from the circuitous rim above the recess.

8. The eyewear of claim 7, wherein the upper prong and lower prong are tapped such that they can be screwed toward one another with a single screw.

9. The eyewear of claim 1, wherein both eyewires are affixed to a nose bridge.

10. The eyewear of claim 6, wherein a surface of the eyewire disposed forward of the upper and lower prongs is concave and adapted to abut a cantilever of a detachable arm.

11. The eyewear of claim 1, wherein a screw joins the upper prong, the lower prong and the arm.

12. Eyewear comprising:
two eyewires adapted to circumscribe one or more lenses, each eyewire forming a circuitous rim adapted to receive and secure a lens, wherein circuitous continuity an outside edge of each eyewire is interrupted at only a single interruption point on an outside lateral edge of the rim such that the eyewire forms a recess at the single interruption point;
wherein each eyewire is adapted to flex open when opposing tensile forces are applied by hand such that the lens can be inserted or extracted under tensile force;
wherein each eyewire comprises an upper prong cantilevering from the circuitous rim above the recess and a lower prong cantilevering from the circuitous rim below the recess;
two detachable arms, each detachable arm hingedly connected at a proximal end to an eyewire, the proximal end of each arm inserted into the recess of an eyewire, wherein each arm is adapted to rotate axially relative to the eyewire on a longitudinal plane within said recess;
wherein the upper prong and lower prong are tapped such that they can be screwed toward one another with a single screw;
a screw joining the upper prong, the lower prong and the arm and wherein the arm;
a nose bridge affixed to the eyewires.

13. The eyewear of claim 11, wherein each eyewire is substantially annular.

14. Eyewear comprising:
an eyewire adapted to circumscribe one or more lenses and straddle a nose, the eyewire forming one or more circuitous rims, each circuitous rim adapted to receive and secure a lens, wherein circuitous continuity an outside edge of the eyewire is interrupted at a single interruption point on an outside lateral edge of the rim such that the eyewire forms a recess at the single interruption point;
wherein the eyewire is adapted to flex open when opposing tensile forces are applied by hand such that the lens can be inserted or extracted under tensile force;
wherein the eyewire comprises an upper prong cantilevering from the circuitous rim above the recess and a lower prong cantilevering from the circuitous rim below the recess;
two detachable arms, each detachable arm hingedly connected at a proximal end to the eyewire, the proximal end of each arm inserted into a recess of the eyewire, wherein each arm is adapted to rotate axially relative to the eyewire on a longitudinal plane within said recess.

15. The eyewear of claim 14, wherein the eyewire is formed from one of polymeric and organic materials.

16. The eyewear of claim 14, wherein the upper and lower prongs are tapped.

17. The eyewear of claim 14, wherein the eyewire forms a recessed groove for receiving the lens.

18. The eyewear of claim 14, wherein a surface of the eyewire disposed forward of the upper and lower prongs is concave and adapted to abut a cantilever of a detachable arm.

19. The eyewire of claim 14, further comprising a screw adapted to join the upper prong and the lower prong and the arm such that the arm pivots about a plane orthogonal to a longitudinal axis of the screw.

20. The eyewear of claim 14, wherein a rearward surface of the eyewire disposed forward of the upper and lower prongs is concave and adapted to receive a squish pad.
